(19) United States
(12) Patent Application Publication
(10) Pub. No.: US 2017/0190374 A1
(43) Pub. Date: Jul. 6, 2017

(54) Engagement Mechanism Assembly for a Scooter

(71) Applicant: Edge Brands, Ltd, Kowloon (CN)

(72) Inventor: Brian Quaglia, Rehoboth, MA (US)

(73) Assignee: Edge Brands, Ltd., Kowloon (CN)

(21) Appl. No.: 15/397,316

(22) Filed: Jan. 3, 2017

Related U.S. Application Data
(60) Provisional application No. 62/274,343, filed on Jan. 3, 2016.

(51) Int. Cl. B62K 5/02; B62L 3/02; B62L 1/02; B62K 5/06; B62K 15/00

(52) U.S. Cl. CPC B62K 5/02; B62K 5/06; B62K 15/008; B62L 1/02; B62L 3/02

(57) ABSTRACT

A scooter may include a front wheel assembly, a steering column, a first bracket, a reconfigure assembly, a pair of legs, and a pair of rear wheel assemblies. The steering column may be mounted to the front wheel assembly and partially disposed within a steering column housing. The first bracket may extend from the steering column housing and include a lock mechanism to engage the steering column housing in an upright position and a stowed position. Each of the pair of legs may be mounted to the reconfigure assembly for selective pivotal movement. The lock mechanism, reconfigure assembly, and legs may be arranged with one another such that the steering column may transition between at least a stowed position and an upright position and such that the legs may transition between an open position and a closed position.

### CROSS-REFERENCE TO RELATED APPLICATIONS

This application claims the benefit of U.S. provisional application Ser. No. 62/274,343 filed Jan. 3, 2016, the disclosure of which is hereby incorporated in its entirety by reference herein.

### TECHNICAL FIELD

The present disclosure relates to scooters and assemblies to facilitate scooter reconfiguration.

### BACKGROUND

Propulsion scooters are used for recreation, fitness, and transportation. These scooters typically take advantage of a resultant force that may be gained by a repetitive single user motion in combination with an appropriate mechanical configuration of the scooter. Mechanical assemblies may assist in facilitating a transition of the scooter between various configurations.

### SUMMARY

According to an embodiment, a scooter includes a first bracket, a front wheel, a steering column, a second bracket, a reconfigure assembly, a pair of legs, and a pair of wheels. The front wheel is mounted to the first bracket for rotation. The steering column extends from the first bracket. The second bracket extends from a steering column housing. The reconfigure assembly is mounted to the second bracket. Each of the pair of legs is mounted to the reconfigure assembly at a first end for movement between at least a first and a second position. Each of the pair of wheels is mounted for rotation to a second end of one of the legs. The steering column may be partially disposed within the steering column housing such that the steering column and front wheel rotate independent of the second bracket. The scooter may further include a brake mechanism. The brake mechanism may include a brake line at least partially disposed within the steering column. A lock mechanism may engage the pair of legs in the first and second positions. The second bracket may further include a lock mechanism for engaging the steering column in an upright position and a folded position. The reconfigure assembly may include a pair of cams, a base member, a spring, a slidable guide member, an actuator, and an engagement member. The actuator may be arranged with the cams such that application of a force to the actuator selectively engages or disengages the cams for translation of the pair of legs between the first and second positions. The reconfigure assembly may include a pair of cams and a rotatable and slidable pin. Each of the pair of cams may define a first through-hole for substantial registration with one another when the pair of legs is in the first position and a second through-hole for substantial registration with one another when the pair of legs is in the second position. The rotatable and slidable pin may be sized for insertion within the first through-holes and the second through-holes when in substantial registration with one another to retain the pair of legs in the first position or the second position.

According to an embodiment, a reconfigure assembly for a scooter includes a housing, a pair of cams, a base member, a spring, a slidable guide member, an actuator, and an engagement member. The housing is sized to receive a first end of each of a pair of legs. Each of the pair of cams is mounted to one of the first ends and defines a hook portion. The base member is mounted to a lower portion of the housing, defines a cavity, and is located between the first ends. The spring is disposed within the cavity. The slidable guide member is sized for at least partial disposal within the cavity and arranged with the spring such that the spring biases movement of the slidable guide member. The actuator is mounted to an upper portion of the housing and arranged with the slidable guide member to direct movement of the slidable guide member within the cavity. The engagement member is mounted to the slidable guide member and defines an extension sized for selective engagement with the hook portions of the cams. The actuator is arranged with the cams such that application of a force to the actuator selectively engages or disengages the extension with the hook portions for movement of the pair of legs between at least a first and second position. The housing may be sized for pivotal movement of a portion of each of the pair of legs within the housing. A bracket may extend from the housing to a steering column housing. The bracket may include a lock mechanism to engage the steering column housing in an upright position and a stowed position. A front wheel may be mounted for rotation to a steering column partially disposed within the steering column housing. The steering column housing and the steering column may be arranged with one another such that the steering column and a front wheel mounted to a lower portion of the steering column rotate independently of the steering column housing. The base member may be disposed between the pair of legs. The first position may be an open position and the second position may be a closed position.

According to an embodiment, a scooter includes a front wheel assembly, a steering column, a first bracket, a reconfigure assembly, a pair of legs, and a pair of rear wheel assemblies. The front wheel assembly includes a front wheel. The steering column is mounted to the front wheel assembly and partially disposed within a steering column housing. The first bracket extends from the steering column housing and includes a lock mechanism to engage the steering column housing in an upright position and a stowed position. The reconfigure assembly is mounted to the first bracket. Each of the pair of legs is mounted to the reconfigure assembly for selective pivotal movement. Each of the pair of rear wheel assemblies is mounted to one of the pair of legs. The lock mechanism, reconfigure assembly, and legs are arranged with one another such that the steering column may transition between at least a stowed position and an upright position and such that the legs may transition between an open position and a closed position. The reconfigure assembly may further include a pair of cams, a base member, a spring, a slidable guide member, an actuator, and an engagement member. The actuator may be arranged with the cams such that application of a force to the actuator selectively engages or disengages cams for translation of the pair of legs between the open position and the closed position. The reconfigure assembly may include a pair of cams and a rotatable and slidable pin. Each of the pair of cams may define a first through-hole for substantial registration with one another when the pair of legs is in the open position and a second through-hole for substantial registration with one another when the pair of legs is in the closed position. The rotatable and slidable pin may be sized for insertion within the first through-holes and the second through-holes when in substantial registration with one another to retain the pair of legs in the open position or the closed position. The steering column housing may be sized for pivotal movement of a portion of each of the pair of legs within the steering column housing. The scooter may include a brake mechanism having a brake line at least partially disposed within the steering column.

### BRIEF DESCRIPTION OF THE DRAWINGS

FIG. 1 is a perspective view of an example of a scooter with a portion of the scooter shown in an exploded view.

FIG. 2 is a front view of the scooter of FIG. 1.

FIG. 3 is a rear view of the scooter of FIG. 1.

FIG. 4 is a first side view of the scooter of FIG. 1.

FIG. 5 is a second side view of the scooter of FIG. 1.

FIG. 6A is a top view of the scooter of FIG. 1 in which the scooter is shown in a first position.

FIG. 6B is a top view of the scooter of FIG. 1 in which the scooter is shown in a second position.

FIG. 6C is a partial side view of the scooter of FIG. 1 showing a portion of a steering column and a bracket rotated from a vertical orientation relative to an underlying surface

FIG. 7 is a bottom view of the scooter of FIG. 1.

FIG. 8A is a side view of the scooter of FIG. 1 in which a portion of the scooter is shown in detail and in cross-section.

FIG. 8B is a partial perspective view of the scooter of FIG. 1 with components removed to show portions of a reconfigure mechanism.

FIG. 9 is a perspective view of an example of a reconfigure mechanism for the scooter of FIG. 1.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ embodiments of the present disclosure. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

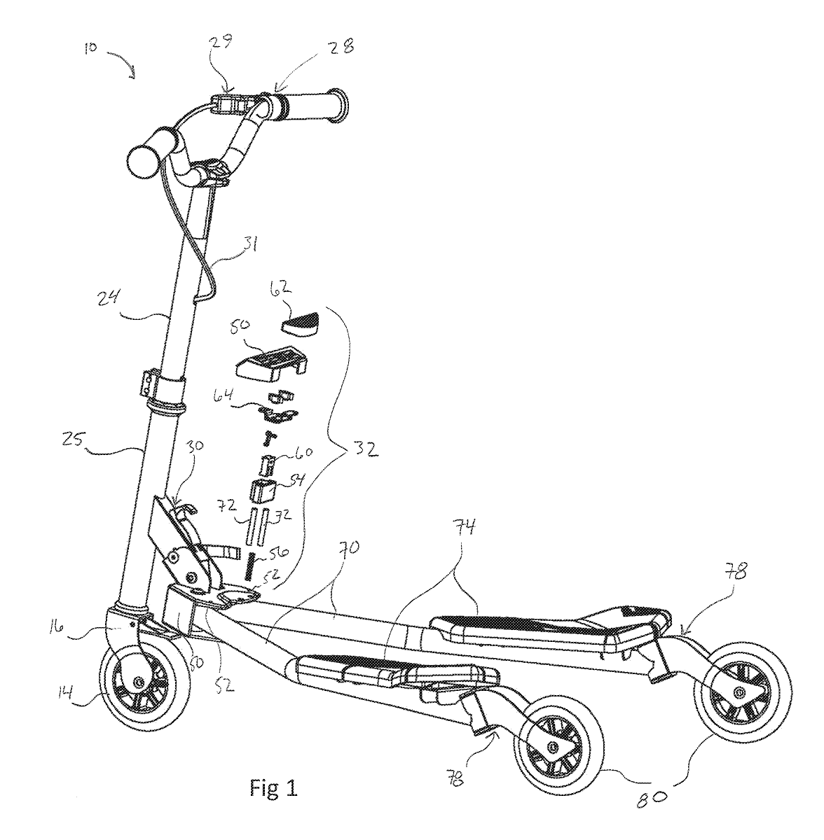

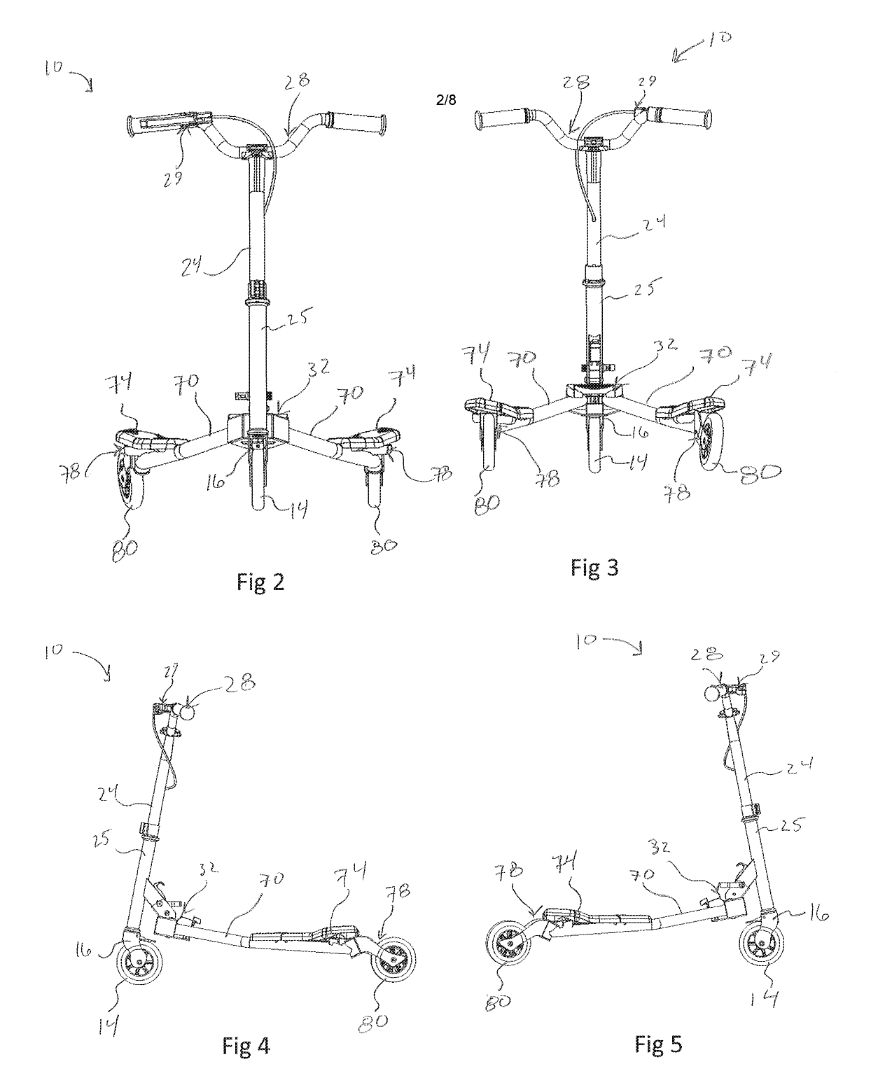

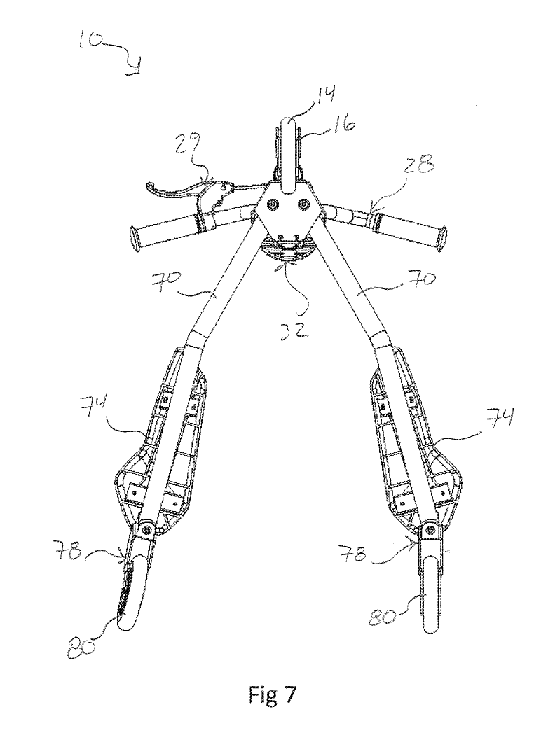

FIGS. 1 through 8B show an example of a scooter assembly, referred to generally as a scooter 10 herein. The scooter 10 may include a front wheel 14 mounted for rotation to a first bracket 16. The first bracket 16 may be mounted to a steering column 24 such that the front wheel 14 and steering column 24 may rotate together. A handle bar assembly 28 may be secured to the steering column 24. A portion of a brake mechanism 29 may be mounted to, for example, the handle bar assembly 28. A brake line 31 may at extend from the brake mechanism 29 and at least partially within the steering column 24. A second bracket 30 may extend from a steering column housing 25. The steering column 24 may be at least partially disposed within the steering column housing 25 such that the steering column 24 rotates independent of the second bracket 30. An engagement mechanism, such as a reconfigure assembly 32, may be mounted to the second bracket 30. The reconfigure assembly 32 may assist in transitioning the scooter 10 between various configurations as further described herein. The reconfigure assembly 32 is shown exploded in FIG. 1; however the reconfigure assembly 32 is shown assembled in FIGS. 2 through 7.

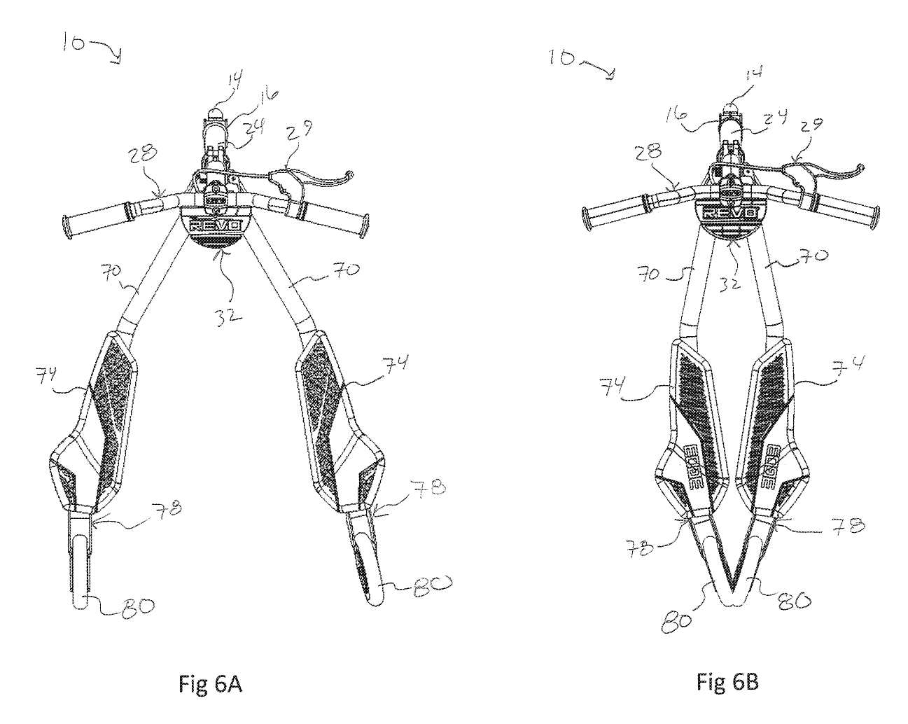

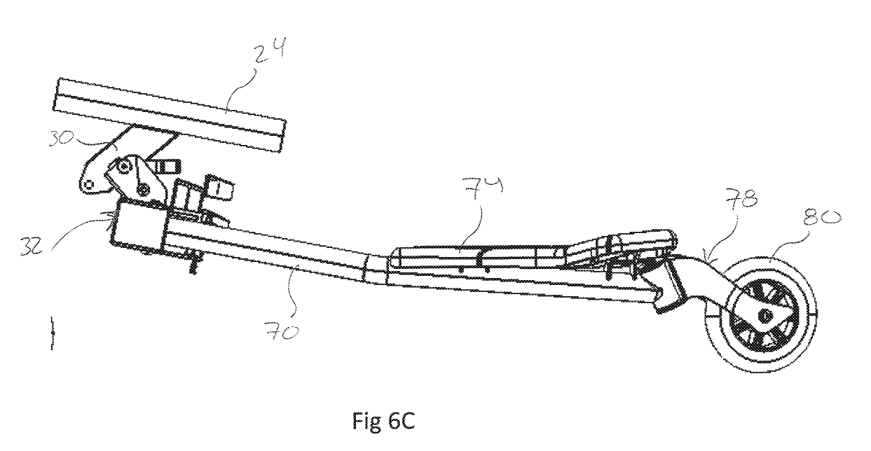

The reconfigure assembly 32 may include a housing 50, a pair of cams 52, a base member 54, a spring 56, a slidable guide member 60, an actuator 62, and an engagement member 64. A pair of legs 70 may extend from the reconfigure assembly 32. A set of posts 72 may be mounted to the housing 50 to assist in orienting the base member 54. Each of the pair of legs 70 may include first ends mounted to the reconfigure assembly 32 for pivotal movement between at least a first and a second position. For example, FIG. 6A shows the pair of legs 70 oriented in a first position or an open position and FIG. 6B shows the pair of legs 70 oriented in a second position or a closed position.

Each of a pair of decks 74 may be mounted to one of the pair of legs 70. The pair of decks 74 may provide support for a user thereon during, for example, use of the scooter 10. Each of a pair of rear wheel assemblies 78 may be mounted for pivotal movement to a rear end of one of the pair of legs 70. Each of the pair of rear wheel assemblies 78 may include a rear wheel 80 mounted for rotation. The brake mechanism 29 may be operably connected to the front wheel 14 to assist in managing brake applications to the front wheel 14.

The second bracket 30 may also be mounted to the reconfigure assembly 32 for selective pivotal rotation. FIG. 6C shows the second bracket 30 and a portion of the steering column 24 rotated from a substantially vertical position as shown in the other figures. The second bracket 30 may be mounted to the reconfigure assembly 32 such that the steering column 24, and other components mounted thereto, may pivot between at least two positions, such as an upright position for use by a user and a stowed position for storage. For example, rotating the second bracket 30 to the stowed position may provide for a compact configuration of the scooter 10 for storage thereof. A lock mechanism may assist in retaining the second bracket 30 in a position, such as the upright or stowed position.

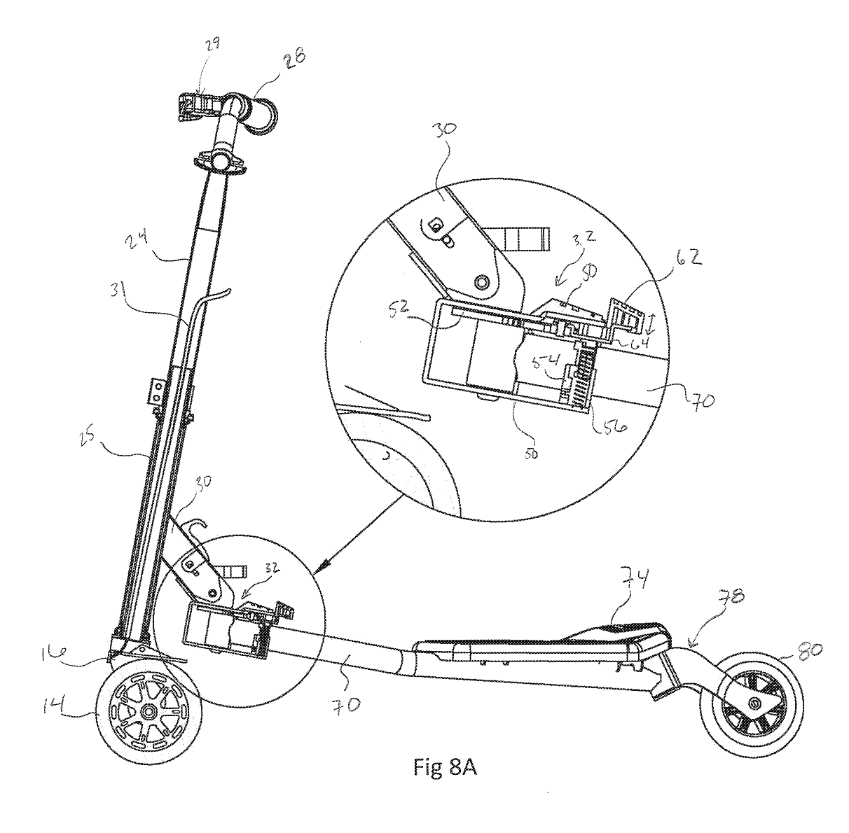

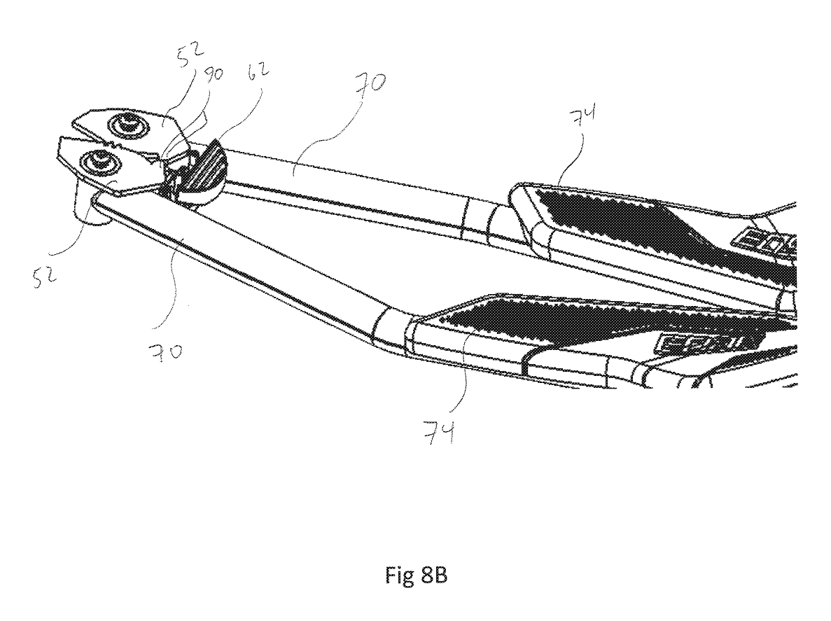

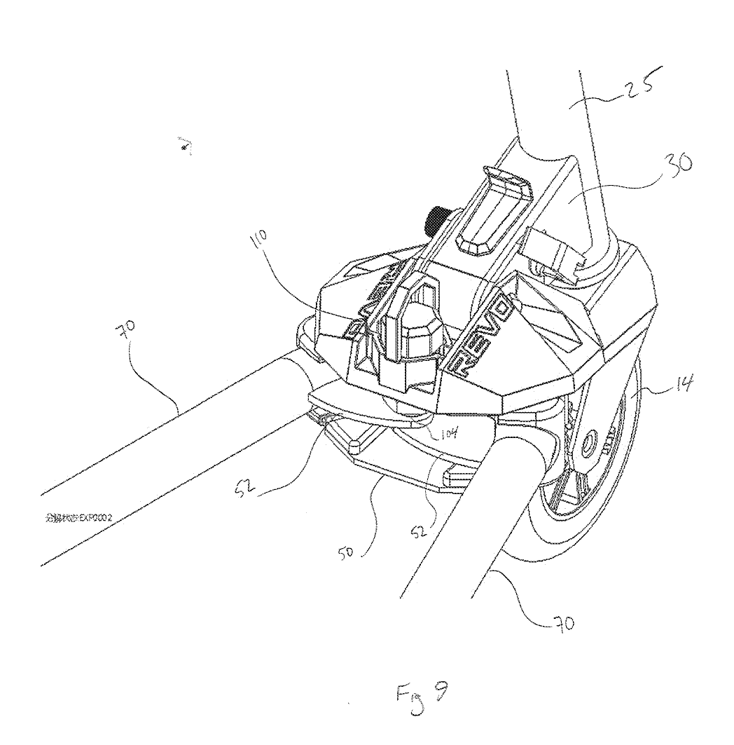

FIGS. 1, 8A, and 8B, show additional details of the reconfigure assembly 32. For example, each of the pair of legs 70 may be mounted to the reconfigure assembly 32 at a first end of the pair of legs 70 for pivotal rotation between at least the first and second positions. The housing 50 may be sized to receive the first end of each of the pair of legs 70 and to facilitate pivotal movement of a portion of each of the pair of the legs 70. Each of the pair of cams 52 may be mounted to one of the pair of legs 70. Each of the pair of cams 52 may define a hook portion 90. The base member 54 may be mounted to a lower portion of the housing 50 and may define a cavity. The base member 54 may be located between the pair of legs 70. The cavity may be sized to receive the spring 56 and the slidable guide member 60. The slidable guide member 60 may be sized for at least partial disposal within the cavity. The slidable guide member 60 may be arranged with the spring 56 such that the spring may bias movement thereof.

The actuator 62 may be mounted to an upper portion of the housing 50 for translation. The actuator 62 may be arranged with the slidable guide member 60 such that application of a force to the actuator 62 directs translation of the slidable guide member 60 within the cavity of the base member 54. The engagement member 64 may be operably connected to the slidable guide member 60. The engagement member 64 may include a portion arranged with the pair of cams 52 such that movement of the slidable guide member 60 may engage and disengage the pair of legs 70 such that the pair of legs 70 may transition between the first and second positions. For example, the engagement member 64 may define an extension sized for selective engagement or contact with one of the hook portions 90 of the pair of cams 52. The actuator 62 may be arranged with the pair of cams 52 such that application of a force to the actuator 62 engages or disengages the extension with the hook portions 90. Thus, the pair of cams 52 may rotate with the pair of legs 70 and be selectively retained in multiple positions to pivot the pair of legs 70 between the first and second positions.

FIG. 9 shows another example of the reconfigure assembly 32. In this example, the reconfigure assembly 32 may include the housing 50, the pair of cams 52, and an engagement member 100. One of the cams 52 may include a first through-hole 104 and a second through-hole (not visible in FIG. 9). The other of the cams 52 may include a third through-hole (not visible in FIG. 9) for substantial registration with first through-hole 104 when the pair of legs 70 is oriented in the first position. The other of the cams 52 may also include a fourth through-hole (not visible in FIG. 9) for substantial registration with the second through-hole for substantial registration with the second through-hole when the pair of legs 70 is oriented in the second position. A rotatable and slidable engagement member 110 may be sized for insertion within the through-holes when respectively in substantial registration with one another to retain the pair of legs 70 in the first position or the second position.

While various embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to marketability, appearance, consistency, robustness, customer acceptability, reliability, accuracy, etc. As such, embodiments described as less desirable than other embodiments or prior art implementations with respect to one or more characteristics are not outside the scope of the disclosure and can be desirable for particular applications.

What is claimed is:

1. A scooter comprising:
a first bracket;
a front wheel mounted to the first bracket for rotation;
a steering column extending from the first bracket;
a second bracket extending from a steering column housing;
a reconfigure assembly mounted to the second bracket;
a pair of legs, each mounted to the reconfigure assembly at a first end for movement between at least a first and a second position; and
a pair of rear wheels each mounted for rotation to a second end of one of the legs.

2. The scooter of claim 1, wherein the steering column is partially disposed within the steering column housing such that the steering column and front wheel rotate independent of the second bracket.

3. The scooter of claim 1 further comprising a brake mechanism, wherein a brake line of the brake mechanism is at least partially disposed within the steering column.

4. The scooter of claim 1, wherein the reconfigure assembly comprises a lock mechanism to engage the pair of legs in the first and second positions.

5. The scooter of claim 1, wherein the second bracket further includes a lock mechanism for engaging the steering column in an upright position and a folded position.

6. The scooter of claim 1, wherein the reconfigure assembly comprises:
a pair of cams;
a base member;
a spring;
a slidable guide member;
an actuator; and
an engagement member,
wherein the actuator is arranged with the cams such that application of a force to the actuator selectively engages or disengages the cams for translation of the pair of legs between the first and second positions.

7. The scooter of claim 1, wherein the reconfigure assembly comprises:
a pair of cams each defining a first through-hole for substantial registration with one another when the pair of legs is in the first position and a second through-hole for substantial registration with one another when the pair of legs is in the second position; and
a rotatable and slidable pin sized for insertion within the first through-holes and the second through-holes when in substantial registration with one another to retain the pair of legs in the first position or the second position.

8. A reconfigure assembly for a scooter comprising:
a housing sized to receive a first end of each of a pair of legs;
a pair of cams each mounted to one of the first ends and defining a hook portion;
a base member mounted to a lower portion of the housing, defining a cavity, and located between the first ends;
a spring disposed within the cavity;
a slidable guide member sized for at least partial disposal within the cavity and arranged with the spring such that the spring biases movement of the slidable guide member;
an actuator mounted to an upper portion of the housing and arranged with the slidable guide member to direct movement of the slidable guide member within the cavity; and
an engagement member mounted to the slidable guide member and defining an extension sized for selective engagement with the hook portions of the cams,
wherein the actuator is arranged with the cams such that application of a force to the actuator selectively engages or disengages the extension with the hook portions for movement of the pair of legs between at least a first and second position.

9. The assembly of claim 8, wherein the housing is further sized for pivotal movement of a portion of each of the pair of legs within the housing.

10. The assembly of claim 8 further comprising a bracket extending from the housing to a steering column housing, wherein the bracket includes a lock mechanism to engage the steering column housing in an upright position and a stowed position.

11. The assembly of claim 10 further comprising a front wheel mounted for rotation to a steering column partially disposed within the steering column housing, wherein the steering column housing and the steering column are arranged with one another such that the steering column and a front wheel mounted to a lower portion of the steering column rotate independently of the steering column housing.

12. The assembly of claim 8, wherein the base member is disposed between the pair of legs.

13. The assembly of claim 8, wherein the first position is an open position and the second position is a closed position.

14. A scooter comprising:
a front wheel assembly including a front wheel;
a steering column mounted to the front wheel assembly and partially disposed within a steering column housing;
a first bracket extending from the steering column housing and including a lock mechanism to engage the steering column housing in an upright position and a stowed position;
a reconfigure assembly mounted to the first bracket;
a pair of legs, each mounted to the reconfigure assembly for selective pivotal movement; and
a pair of rear wheel assemblies, each mounted to one of the pair of legs,
wherein the lock mechanism, reconfigure assembly, and legs are arranged with one another such that the steering column may transition between at least a stowed position and an upright position and such that the legs may transition between an open position and a closed position.

15. The scooter of claim 14, wherein the reconfigure assembly further comprises:
a pair of cams;
a base member;
a spring;
a slidable guide member;
an actuator; and
an engagement member,
wherein the actuator is arranged with the cams such that application of a force to the actuator selectively engages or disengages cams for translation of the pair of legs between the open position and the closed position.

16. The scooter of claim 14, wherein the reconfigure assembly comprises:
a pair of cams each defining a first through-hole for substantial registration with one another when the pair of legs is in the open position and a second through-hole for substantial registration with one another when the pair of legs is in the closed position; and
a rotatable and slidable pin sized for insertion within the first through-holes and the second through-holes when in substantial registration with one another to retain the pair of legs in the open position or the closed position.

17. The scooter of claim 14, wherein the steering column housing is further sized for pivotal movement of a portion of each of the pair of legs within the steering column housing.

18. The scooter of claim 14 further comprising a brake mechanism having a brake line at least partially disposed within the steering column.
